(19) United States
(12) Patent Application Publication
(10) Pub. No.: US 2024/0070924 A1
(43) Pub. Date: Feb. 29, 2024

(54) COMPRESSION OF TEMPORAL DATA BY USING GEOMETRY-BASED POINT CLOUD COMPRESSION

(71) Applicants: Koninklijke KPN N.V., Rotterdam (NL); Nederlandse Organisatie Voor Toegepast-Natuurwetenschappelijk Onderzoek TNO, 's-Gravenhage (NL)

(72) Inventors: Alexandre da Silva Pratas Gabriel, The Hague (NL); Sylvie Dijkstra-Soudarissanane, 's-Gravenhage (NL); Emmanouil Potetsianakis, The Hague (NL)

(21) Appl. No.: 18/268,113

(22) PCT Filed: Dec. 15, 2021
(86) PCT No.: PCT/EP2021/086000

§ 371 Date: Jun. 16, 2023

(30) Foreign Application Priority Data
Dec. 21, 2020 (EP) 20216163.4

(51) Int. Cl. G06T 9/00

(52) U.S. Cl. CPC G06T 9/001

(57) ABSTRACT

A compression system is configured to obtain a plurality (231) of two-dimensional arrays (234-239) of element values, e.g. a plurality of video frames. Same positions in different arrays comprise a value of the same element at a different moment. The compression system is further configured to convert the plurality of two-dimensional arrays of element values to a three-dimensional point cloud (232), which comprises a plurality of data points, by mapping the positions of the element values in the plurality of two-dimensional arrays to coordinates of the data points and associating each of the element values with a corresponding data point in the point cloud. The compression system is further configured to apply geometry-based point cloud compression to the three-dimensional point cloud.

### FIELD OF THE INVENTION

The invention relates to a compression system and a decompression system.

The invention further relates to a method of compressing two-dimensional arrays of element values, e.g. video frames, and a method of decompressing compressed two-dimensional arrays of element values.

The invention also relates to a computer program product enabling a computer system to perform such methods.

### BACKGROUND OF THE INVENTION

Currently, the state of the art on video compression relies on spatial and temporal redundancies between video frames to achieve compression. Modern standards like AVC, AV1, and VVC use techniques like motion estimation and motion compensation that use inter- and intra-frame prediction to achieve compression, as described in “An overview of emerging video coding standards” by T. Zhang and. S. Mao, in GetMobile Volume 22, Issue 4, December 2018. Efficient video coding typically involves separating images in pixel “blocks” (typical values are 4×4 and 8×8 going up to 64×64 in HEVC extensions) and trying to find intra- and inter-frame redundancies.

However, as display resolutions continue to increase and video resolutions continue to increase accordingly, it is desirable to develop compression techniques which are able to compress video more efficiently such that transmission data rates and file sizes can be reduced without (substantially) reducing the quality of the video.

Due to the increasing use of sensors, the compression of sensor data is very relevant as well. The paper “Practical data compression in wireless sensor networks: A survey” by Tossaporn Srisooksai et al., published in Journal of Network and Computer Applications, Volume 35, Issue 1, January 2012, Pages 37-59, describes multiple techniques for compressing data derived from a sensor. Many techniques (typically entropy compression techniques) use a dictionary due to the similarity of the data. Sometimes, characteristics of the sensor data are used (e.g. standard deviation, mean, min, max values) and accordingly modeling or curve-fitting is performed.

### SUMMARY OF THE INVENTION

It is a first objective of the invention to provide a compression system, which can be used to compress two-dimensional arrays of element values more efficiently.

It is a second objective of the invention to provide a decompression system, which can be used to decompress these compressed two-dimensional arrays of element values.

It is a third objective of the invention to provide a method, which can be used to compress two-dimensional arrays of element values more efficiently.

It is a fourth objective of the invention to provide a method, which can be used to decompress these compressed two-dimensional arrays of element values.

In a first aspect of the invention, a compression system comprises at least one processor, the at least one processor being configured to obtain a plurality of two-dimensional arrays of element values, same positions in each of the plurality of two-dimensional arrays comprising a value of the same element at a different moment, convert the plurality of two-dimensional arrays of element values to a three-dimensional point cloud comprising a plurality of data points by mapping the positions of the element values in the plurality of two-dimensional arrays to coordinates of the data points and associating each of the element values with a corresponding data point in the point cloud, and compress the three-dimensional point cloud into a compressed three-dimensional point cloud by applying geometry-based point cloud compression to the three-dimensional point cloud.

For example, video frames may be taken that would typically be encoded by a video encoder and pixels that are in each frame parallel to each other may be placed as data points in a data slice of a 3D point cloud. This simulates a point cloud structure with parallel slices that can then be compressed with geometry-based point cloud compression techniques like MPEG G-PCC or Google Draco. Since consecutive video frames typically comprise the same objects, either at the same position or at a different position, it is often possible to consider an object in consecutive frames as a single geometrical shape, which makes geometry-based compression efficient.

Although it is possible to compress consecutive frames that do not comprise the same objects using geometry-based compression, this will normally not be efficient. Preferably, only video frames of the same scene are encoded in single 3D point cloud to maximize compression efficiency. Instead of color values derived from a camera, non-color values derived from a different type of sensor may also be included in a plurality of two-dimensional arrays and then converted to a three-dimensional point cloud.

In many situations, the same value is derived from a sensor for a longer period of time, e.g. from a temperature sensor or from a humidity sensor, and these same consecutive measurement values may be seen as a single geometrical shape. Furthermore, the same value may be also be derived from neighboring sensors. In this case, values derived from different sensors may be seen as a single geometrical shape. In both cases, geometry-based compression will normally be efficient.

As an additional advantage, if one or more of packets of the compressed point cloud would be lost or corrupted, this would not have the same severe impact that the loss or corruption of one or more packets of an intra-coded frame (e.g. I-frame) would have on the decoding of a dependent inter-coded frame (e.g. P-frame).

The at least one processor of the compression system may be configured to determine desired distances between data points in the three-dimensional point cloud and map the positions of the element values in the plurality of two-dimensional arrays to coordinates of the data points based on the desired distances. These distances may be fixed or automatically determined, e.g. by performing an analysis of the content and/or the underlying technologies.

These distances are preferably not too small to reduce the likelihood that multiple data points end up in the same subspace of the point cloud and are preferably not too large to reduce the overall occupied volume. The desired distances in the three directions may be represented by one distance per axis or by a single value if these distances are the same in all three directions. The desired distances may depend on the minimum distance unit and maximum point cloud size supported by the codec.

The at least one processor of the compression system may be configured to associate metadata indicating dimensions of the plurality of two-dimensional arrays, dimensions of the three-dimensional point cloud, and/or the desired distances with the compressed three-dimensional point cloud. This enables the decompression system to reconstruct the plurality of arrays of element values, e.g. the points in the parallel slices that constitute the frames, from the decompressed point cloud.

In a second aspect of the invention, a decompression system comprises at least one processor, the at least one processor being configured to obtain a compressed three-dimensional point cloud, decompress the compressed three-dimensional point cloud into a three-dimensional point cloud by applying geometry-based point cloud decompression to the compressed three-dimensional point cloud, and convert the point cloud to a plurality of two-dimensional arrays of element values by dividing the three-dimensional point cloud into a plurality of three-dimensional subspaces, selecting a corresponding three-dimensional subspace for each position in the two-dimensional arrays, and determining an element value for each position in the two-dimensional arrays based on one or more values of one or more data points in the corresponding three-dimensional subspace, same positions in each of the plurality of two-dimensional arrays comprising a value of the same element at a different moment.

Typically, the decompression system is able to obtain metadata associated with the compressed three-dimensional point cloud and use this metadata to convert the point cloud to the plurality of two-dimensional arrays of element values. Examples of metadata are distances between the points, dimensions of the point cloud, data types contained in the point cloud, granularity, and map/dictionary (in case there are several types of data inside the same point cloud).

The element values may comprise values derived from at least one sensor, e.g. color values derived from a real camera. If the values are derived from a camera, they would normally be included in video frames as pixel values. Even if the values derived from the sensor(s) are not color values, they may still be included in video frames as pixel values (thereby replacing the normal color values). Alternatively, they may be included in arrays of element values that are not frames. A frame is typically defined as a still image of a set of still images that constitutes a film or video and a digital video frame normally comprises pixel values. If the values derived from the sensor(s) are not color values derived from a camera, it is not necessary to store them as pixel values.

Values not derived from a sensor, e.g. color values derived from a virtual camera, may also be included in video frames as pixel values. The sensor-derived values included in the arrays are typically processed (e.g. normalized, or otherwise filtered), but could also be raw sensor values. The arrays of element values may (temporarily) be stored in memory as arrays or as different data structures.

The decompression system may be a terminal. The decompression system may be, for example, a mobile terminal such as a mobile phone. Alternatively, the decompression system may be a set-top box or a computer, for example. More specific examples of a terminal include a cellular phone, a smartphone, a session initiation protocol (SIP) phone, a laptop, a notebook, a netbook, a smartbook, a personal digital assistant (PDA), a tablet computer, a satellite radio, a global positioning system (GPS) device, a multimedia device, a video device, a digital audio player, a camera, a game console, or any other similar functioning device. A terminal may have a slot for a UICC (also called a SIM card) or be provisioned with an embedded or enhanced version thereof for storage of credentials, for example.

The at least one processor of the decompression system may be configured to obtain metadata indicating dimensions of the plurality of two-dimensional arrays and divide the three-dimensional point cloud into the plurality of three-dimensional subspaces based on the indicated dimensions. This enables the decompression system to reconstruct the plurality of arrays of element values from the decompressed point cloud.

The at least one processor of the decompression system may be configured to determine point cloud dimensions of the three-dimensional point cloud and divide the three-dimensional point cloud into a plurality of three-dimensional subspaces further based on the determined point cloud dimensions. This enables the decompression system to reconstruct the plurality of arrays of element values from the decompressed point cloud. The point cloud dimensions may be determined from obtained metadata or from the point cloud itself.

The at least one processor of the decompression system may be configured to obtain metadata indicating distances between data points in the three-dimensional point cloud before compression and divide the three-dimensional point cloud into the plurality of three-dimensional subspaces further based on the indicated distances. This enables the decompression system to reconstruct the plurality of arrays of element values from the decompressed point cloud. Typically, if the dimensions of the plurality of two-dimensional arrays are known, it is sufficient to determine either the point cloud dimensions or determine the indicated distances and not necessary to determine both.

The at least one processor of the decompression system may be configured to determine for each position in the two-dimensional arrays whether the corresponding three-dimensional subspace comprises at least one data point and if a three-dimensional subspace corresponding to a position in the two-dimensional arrays does not comprise a data point, determine a geometrical shape encompassing the three-dimensional subspace and determine an element value for the position based on one or more element values of one or more data points which are part of the determined geometrical shape. This is beneficial if the compressed three-dimensional point cloud was compressed using lossy geometry-based point cloud compression. For example, in a video frame, each pixel should have a color value and RGB reconstruction may be performed of pixel values which have been lost due to the lossy compression.

The at least one processor of the decompression system may be configured to obtain metadata identifying a method which was used to map positions of element values in an original plurality of arrays to coordinates of the data points of the three-dimensional point cloud before the three-dimensional point cloud was compressed and select the corresponding three-dimensional subspace for each position in the two-dimensional arrays based on the identified method. For example, a default mapping method may map the pixel values of a single frame to data points with the same z coordinate (and different x and y coordinates). However, other mapping methods are also possible, like a mapping method that maps the pixel values of a single frame to data points with the same x coordinate (and different y and z coordinates). If multiple mapping methods are available, the decoder system may need to be informed which mapping method was used in order to reconstruct the frames.

The mapping method may identify the coordinate system used in the mapping such that the compression system and the decompression system have a common notion of the used coordinate system. For example, some 3D systems have point (0,0,0) at the top-left-back corner and only positive movement on the axis is allowed, but others have point (0,0,0) at the center of the scene/object and moving right, front, up would result in positive values, while left, back, down would result in negative values.

In a third aspect of the invention, a method of compressing two-dimensional arrays of element values comprises obtaining a plurality of two-dimensional arrays of element values, same positions in each of the plurality of two-dimensional arrays comprising a value of the same element at a different moment, converting the plurality of two-dimensional arrays of element values to a three-dimensional point cloud comprising a plurality of data points by mapping the positions of the element values in the plurality of two-dimensional arrays to coordinates of the data points and associating each of the element values with a corresponding data point in the point cloud, and compressing the three-dimensional point cloud into a compressed three-dimensional point cloud by applying geometry-based point cloud compression to the three-dimensional point cloud. The method may be performed by software running on a programmable device. This software may be provided as a computer program product.

Each of the two-dimensional arrays of element values is typically an array of values derived from a sensor, e.g. sensor values that have been processed. A frame is a two-dimensional array of values derived from a camera.

In a fourth aspect of the invention, a method of decompressing compressed two-dimensional arrays of element values comprises obtaining a compressed three-dimensional point cloud, decompressing the compressed three-dimensional point cloud into a three-dimensional point cloud by applying geometry-based point cloud decompression to the compressed three-dimensional point cloud, and converting the point cloud to a plurality of two-dimensional arrays of element values by dividing the three-dimensional point cloud into a plurality of three-dimensional subspaces, selecting a corresponding three-dimensional subspace for each position in the two-dimensional arrays, and determining an element value for each position in the two-dimensional arrays based on one or more values of one or more data points in the corresponding three-dimensional subspace, same positions in each of the plurality of two-dimensional arrays comprising a value of the same element at a different moment. The method may be performed by software running on a programmable device. This software may be provided as a computer program product.

Moreover, a computer program for carrying out the methods described herein, as well as a non-transitory computer readable storage-medium storing the computer program are provided. A computer program may, for example, be downloaded by or uploaded to an existing device or be stored upon manufacturing of these systems.

A non-transitory computer-readable storage medium stores at least a first software code portion, the first software code portion, when executed or processed by a computer, being configured to perform executable operations for compressing two-dimensional arrays of element values.

These executable operations comprise obtaining a plurality of two-dimensional arrays of element values, same positions in each of the plurality of two-dimensional arrays comprising a value of the same element at a different moment, converting the plurality of two-dimensional arrays of element values to a three-dimensional point cloud comprising a plurality of data points by mapping the positions of the element values in the plurality of two-dimensional arrays to coordinates of the data points and associating each of the element values with a corresponding data point in the point cloud, and compressing the three-dimensional point cloud into a compressed three-dimensional point cloud by applying geometry-based point cloud compression to the three-dimensional point cloud.

A non-transitory computer-readable storage medium stores at least a second software code portion, the second software code portion, when executed or processed by a computer, being configured to perform executable operations for decompressing compressed two-dimensional arrays of element values.

These executable operations comprise obtaining a compressed three-dimensional point cloud, decompressing the compressed three-dimensional point cloud into a three-dimensional point cloud by applying geometry-based point cloud decompression to the compressed three-dimensional point cloud, and converting the point cloud to a plurality of two-dimensional arrays of element values by dividing the three-dimensional point cloud into a plurality of three-dimensional subspaces, selecting a corresponding three-dimensional subspace for each position in the two-dimensional arrays, and determining an element value for each position in the two-dimensional arrays based on one or more values of one or more data points in the corresponding three-dimensional subspace, same positions in each of the plurality of two-dimensional arrays comprising a value of the same element at a different moment.

As will be appreciated by one skilled in the art, aspects of the present invention may be embodied as a device, a method or a computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit”, “module” or “system.” Functions described in this disclosure may be implemented as an algorithm executed by a processor/microprocessor of a computer. Furthermore, aspects of the present invention may take the form of a computer program product embodied in one or more computer readable medium(s) having computer readable program code embodied, e.g., stored, thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples of a computer readable storage medium may include, but are not limited to, the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of the present invention, a computer readable storage medium may be any tangible medium that can contain, or store, a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber, cable, RF, etc., or any suitable combination of the foregoing. Computer program code for carrying out operations for aspects of the present invention may be written in any combination of one or more programming languages, including an object oriented programming language such as Java™, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems), and computer program products according to embodiments of the present invention. It will be understood that each block of the flowchart illustrations and/or block diagrams, and combinations of blocks in the flowchart illustrations and/or block diagrams, can be implemented by computer program instructions. These computer program instructions may be provided to a processor, in particular a microprocessor or a central processing unit (CPU), of a general purpose computer, special purpose computer, or other programmable data processing apparatus to produce a machine, such that the instructions, which execute via the processor of the computer, other programmable data processing apparatus, or other devices create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of devices, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

### BRIEF DESCRIPTION OF THE DRAWINGS

These and other aspects of the invention are apparent from and will be further elucidated, by way of example, with reference to the drawings, in which:

FIG. 1 is a block diagram of an embodiment of the compression system and an embodiment of the decompression system;

FIG. 2 is a flow diagram of a first embodiment of the compression method and a first embodiment of the decompression method;

FIG. 3 shows an example of a plurality of arrays being converted to a 3D point cloud;

FIG. 4 is a flow diagram of a second embodiment of the compression method and a second embodiment of the decompression method;

FIG. 5 shows an example of plurality of frames being converted to a 3D point cloud;

FIG. 6 illustrates a first approach for mapping pixels of a plurality of frames to a 3D point cloud;

FIG. 7 shows an example of arrays of values derived from sensors other than a camera being converted to a 3D point cloud;

FIG. 8 illustrates how a 3D point cloud may be divided into 3D subspaces;

FIG. 9 is a flow diagram of an implementation of step 135 of FIG. 2;

FIG. 10 illustrates a second approach for mapping pixels of a plurality of frames to a 3D point cloud;

FIG. 11 is a flow diagram of a third embodiment of the compression method and a third embodiment of the decompression method; and

FIG. 12 is a block diagram of an exemplary data processing system for performing the methods of the invention.

Corresponding elements in the drawings are denoted by the same reference numeral.

### DETAILED DESCRIPTION OF THE DRAWINGS

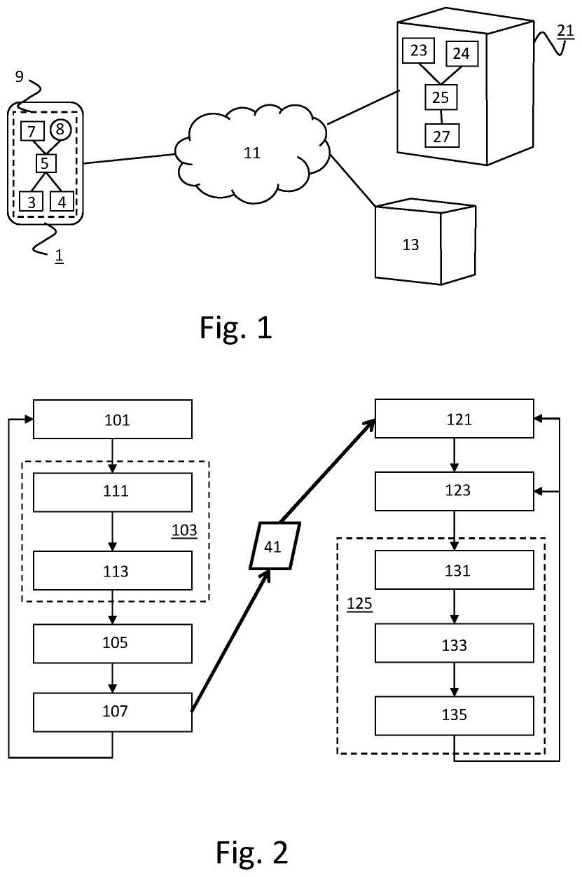

FIG. 1 shows an embodiment of a compression system and an embodiment of a decompression system. FIG. 1 depicts three systems: a terminal 1, a computer 21, and a cloud server 13. All three systems are connected to the Internet 11. The terminal 1 may be a mobile device, for example. The terminal 1 comprises a receiver 3, a transmitter 4, a processor 5, memory 7, a camera 8 and a display 9. The computer 21 comprises a receiver 23, a transmitter 24, a processor 25, and storage means 27.

The terminal 1, the computer 21, or both, may be a compression system. The processor 5 and/or 25 is/are configured to obtain a plurality of two-dimensional arrays of element values (e.g. video frames), convert the plurality of two-dimensional arrays of element values to a three-dimensional point cloud comprising a plurality of data points, and compress the three-dimensional point cloud into a compressed three-dimensional point cloud by applying geometry-based point cloud compression to the three-dimensional point cloud.

Same positions in each of the plurality of two-dimensional arrays comprise a value of the same element at a different moment. This is typical for video frames, but the elements can also be derived from a sensor other than a camera. The processor 5 and/or 25 is/are configured to convert the plurality of two-dimensional arrays of element values to the three-dimensional point cloud by mapping the positions of the element values in the plurality of two-dimensional arrays to coordinates of the data points and associating each of the element values with a corresponding data point in the point cloud.

The terminal 1, the computer 21, or both, may be a decompression system. The processor 5 and/or 25 is/are configured to obtain a compressed three-dimensional point cloud, decompress the compressed three-dimensional point cloud into a three-dimensional point cloud by applying geometry-based point cloud decompression to the compressed three-dimensional point cloud, and convert the point cloud to a plurality of two-dimensional arrays of element values.

The processor 5 and/or 25 is/are configured to convert the point cloud to the plurality of two-dimensional arrays of element values by dividing the three-dimensional point cloud into a plurality of three-dimensional subspaces, selecting a corresponding three-dimensional subspace for each position in the two-dimensional arrays, and determining an element value for each position in the two-dimensional arrays based on one or more values of one or more data points in the corresponding three-dimensional subspace. Same positions in each of the plurality of two-dimensional arrays comprise a value of the same element at a different moment.

The following are examples of scenarios that involve one or more of the three systems:
The terminal 1 compresses a video stream (e.g. captured with camera 8), stores the resulting compressed 3D point cloud in memory 7, and later decompresses it again;
The terminal 1 compresses a video stream and transmits the resulting compressed 3D point cloud to computer 21. The computer 21 then decompresses the compressed 3D point cloud;
The terminal 1 compresses a video stream and transmits the resulting compressed 3D point cloud to cloud server 13. The terminal 1 and/or the computer 21 later receive the compressed 3D point cloud from the cloud server 13 and decompress it;
The computer 21 compresses a video stream, stores the resulting compressed 3D point cloud in memory 27, and later decompresses it again;
The computer 21 compresses a video stream and transmits the resulting compressed 3D point cloud to terminal 1. The terminal 1 then decompresses the compressed 3D point cloud;
The computer 21 compresses a video stream and transmits the resulting compressed 3D point cloud to cloud server 13. The terminal 1 and/or the computer 21 later receive the compressed 3D point cloud from the cloud server 13 and decompress it.

In the embodiment of the terminal 1 shown in FIG. 1, the terminal 1 comprises one processor 5. In an alternative embodiment, the terminal 1 comprises multiple processors. The processor 5 of the terminal 1 may be a general-purpose processor, e.g. from ARM or Qualcomm or an application-specific processor. The processor 5 of the terminal 1 may run an Android or iOS operating system for example. The display 9 may comprise an LCD or OLED display panel, for example. The display 9 may be a touch screen, for example. The processor 5 may use this touch screen to provide a user interface, for example. The memory 7 may comprise one or more memory units. The memory 7 may comprise solid state memory, for example. The camera 8 may comprise a CCD or CMOS sensor, for example.

The receiver 3 and the transmitter 4 may use one or more wireless communication technologies, e.g. Wi-Fi (IEEE 802.11) for communicating with other devices, for example. In an alternative embodiment, multiple receivers and/or multiple transmitters are used instead of a single receiver and a single transmitter. In the embodiment shown in FIG. 1, a separate receiver and a separate transmitter are used. In an alternative embodiment, the receiver 3 and the transmitter 4 are combined into a transceiver. The terminal 1 may comprise other components typical for a terminal such as a battery and a power connector. The invention may be implemented using a computer program running on one or more processors.

In the embodiment of the computer 21 shown in FIG. 1, the computer 21 comprises one processor 25. In an alternative embodiment, the computer 21 comprises multiple processors. The processor 25 of the computer 21 may be a general-purpose processor, e.g. from Intel or AMD, or an application-specific processor. The processor 25 of the computer 21 may run a Windows or Unix-based operating system for example. The storage means 27 may comprise one or more memory units. The storage means 27 may comprise one or more hard disks and/or solid-state memory, for example. The storage means 27 may be used to store an operating system, applications and application data, for example.

The receiver 23 and the transmitter 24 may use one or more wired and/or wireless communication technologies such as Ethernet and/or Wi-Fi (IEEE 802.11) to communicate with other devices, for example. In an alternative embodiment, multiple receivers and/or multiple transmitters are used instead of a single receiver and a single transmitter. In the embodiment shown in FIG. 1, a separate receiver and a separate transmitter are used. In an alternative embodiment, the receiver 23 and the transmitter 24 are combined into a transceiver. The computer 21 may comprise other components typical for a computer such as a power connector. The invention may be implemented using a computer program running on one or more processors.

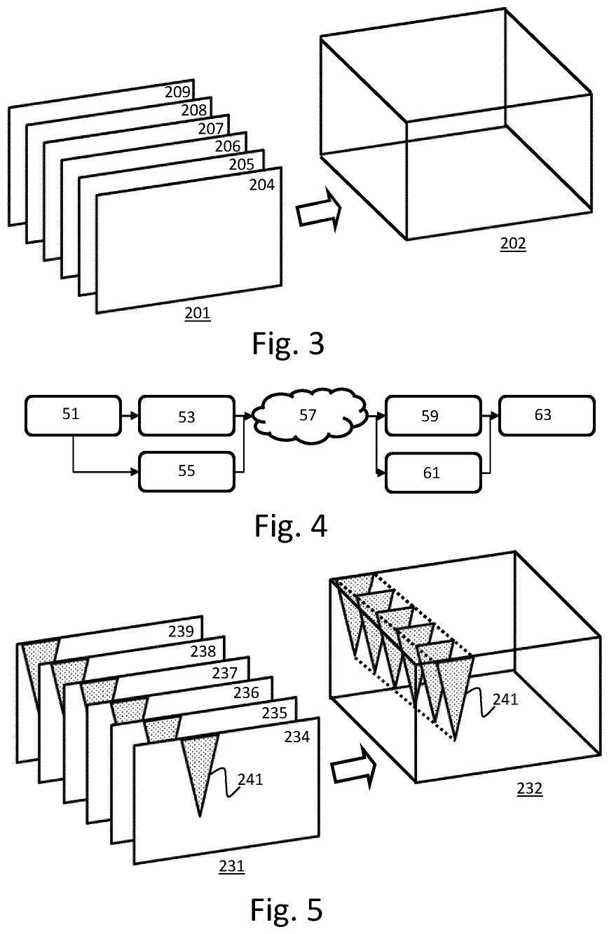

An embodiment of the method of compressing two-dimensional arrays of element values and an embodiment of the method of decompressing compressed two-dimensional arrays of element values are shown in FIG. 2. A step 101 comprises the compression system obtaining a plurality of two-dimensional arrays of element values. Same positions in each of the plurality of two-dimensional arrays comprise a value of the same element at a different moment.

A step 103 comprises the compression system converting the plurality of two-dimensional arrays of element values to a three-dimensional point cloud comprising a plurality of data points. Step 103 is implemented by sub steps 111 and 113. Step 111 comprises mapping the positions of the element values in the plurality of two-dimensional arrays to coordinates of the data points. Step 113 comprises associating each of the element values with a corresponding data point in the point cloud. In general, a point cloud is a set of 3D points of which each point may or may not have associated properties (e.g. color, luminosity). The point cloud created in step 103 has associated properties, e.g. RGB color values if the arrays are video frames.

A step 105 comprises the compression system compressing the three-dimensional point cloud into a compressed three-dimensional point cloud 41 by applying geometry-based point cloud compression to the three-dimensional point cloud. A step 107 comprises the compression system storing and/or transmitting the compressed three-dimensional point cloud 41, e.g. to the decompression system or to another system. Video can be compressed and streamed in real-time by transmitting the point cloud 41 in step 107. If there are one or more additional pluralities of two-dimensional arrays to be compressed, step 101 is repeated after step 107, after which the method proceeds as shown in FIG. 2.

In an alternative embodiment, step 107 comprises temporarily storing the compressed three-dimensional point cloud 41 without transmitting the point cloud and an additional step is performed after step 107 as soon as compressed point clouds have been created for each plurality of frames of a video. This additional step comprises transmitting the plurality of compressed point clouds, e.g. to the decompression system or to another system.

A step 121 comprises the decompression system receiving a compressed three-dimensional point cloud 41, e.g. from the compression system or from another system. In an alternative embodiment, the three-dimensional point cloud 41 is obtained in another way, e.g. from a local memory. A step 123 comprises the decompression system decompressing the compressed three-dimensional point 41 cloud into a three-dimensional point cloud by applying geometry-based point cloud decompression to the compressed three-dimensional point cloud.

A step 125 comprises the decompression system converting the point cloud to a plurality of two-dimensional arrays of element values. Step 125 is implemented by sub steps 131, 133, and 135. Step 131 comprises dividing the three-dimensional point cloud into a plurality of three-dimensional subspaces. Step 133 comprises selecting a corresponding three-dimensional subspace for each position in the two-dimensional arrays. Step 135 comprises determining an element value for each position in the two-dimensional arrays based on one or more values of one or more data points in the corresponding three-dimensional subspace. Same positions in each of the plurality of two-dimensional arrays comprise a value of the same element at a different moment.

Step 121 or step 123 is repeated after step 135, after which the method proceeds as shown in FIG. 2. Step 121 may be repeated after step 135, for example, if video is being streamed. If step 123 is repeated after step 135, then all compressed 3D point clouds that form a video stream/file are typically received in step 121.

FIG. 3 shows an example of a plurality of arrays being converted to a 3D point cloud. A group 201 of six arrays 204-209 is taken and the elements that are in each array/data plan are placed parallel to each other in a 3D point cloud 202. This simulates a point cloud structure with parallel slices that can then be encoded with point cloud compression techniques. A geometry-based point cloud compression algorithm is used to compress the newly made point cloud.

The arrays may be video frames and the data points may be pixels, for example. While the video frames would normally be encoded by a video encoder at this moment, they are now converted to a point cloud and compressed using geometry-based compression. The geometric compression techniques applied would substitute the temporal techniques typically used.

FIG. 4 is a flow diagram of a second embodiment of the compression method and a second embodiment of the decompression method. In these embodiments, the two-dimensional arrays of element values are frames comprising pixel values and the element values comprise color values.

In a step 51, a sequence of raw (uncompressed) video frames is received and organized into a 3D point cloud. In step 51, desired distances between data points in the three-dimensional point cloud are determined and the positions of the element values in the plurality of two-dimensional arrays are mapped to coordinates of the data points based on the desired distances. In other words, each of the frames and each of the pixels are set at a selected distance from each other in the 3D point cloud. In this embodiment, each frame corresponds to a slice in the 3D point cloud.

In a step 53, the sequence of frames is encoded using geometry-based point cloud compression. In the embodiment of FIG. 4, the compression method comprises a step 55. In step 55, metadata relating to the sequence and/or to the mapping performed in step 51 is determined and associated with the compressed 3D point cloud. The metadata may indicate dimensions (i.e. resolution) of the frames, dimensions of the three-dimensional point cloud, and/or the distances used in step 51. In an alternative embodiment, step 55 is omitted.

In a step 57, the compressed 3D point cloud is stored or transmitted. In a step 59, the compressed 3D point cloud is decompressed. In the embodiment of FIG. 4, the decompression method comprises a step 61. In step 61, the metadata associated with the compressed 3D point cloud is extracted. In a step 63, once the point cloud has been decompressed, the frames are reconstructed from the decompressed 3D point cloud using the metadata extracted in step 61. In an alternative embodiment, metadata is only used in the initialization phase of the decompression method/software. In this alternative embodiment, the metadata is not specific to a certain group of frames or even to a video stream and not associated with the 3D point cloud.

FIG. 5 shows an example of plurality of frames being converted to a 3D point cloud using the method of FIG. 4. Each frame 234-239 of a group 231 comprises the same object 241. When the group 231 is converted to a 3D point cloud 232 each data slice of the point cloud 232 comprises the same object 241 (the dashed lines are shown for illustrative purposes only). Due to the spatial correlation between RGB color values, it is possible to compress the 3D point cloud efficiently using geometry-based point cloud compression.

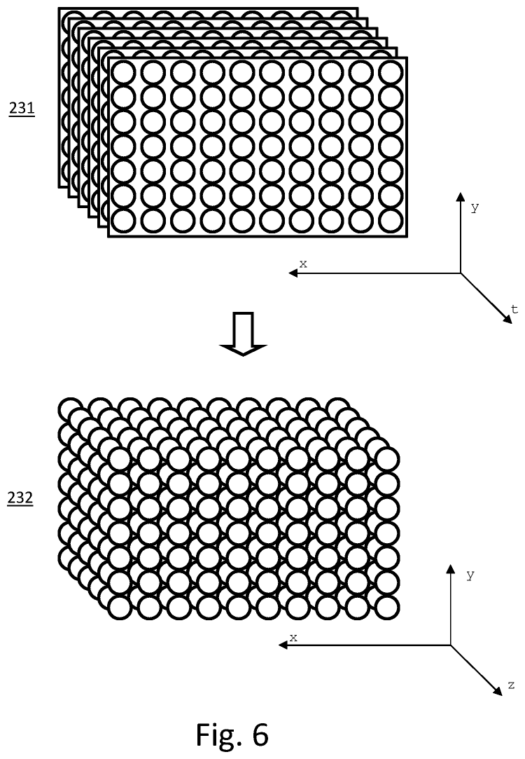

FIG. 6 illustrates a first approach for mapping pixels of a plurality of frames to a 3D point cloud. As described in relation to step 51 of FIG. 4, first, raw frames are extracted from the video sequence. As an abstraction, each pixel of a frame can be reduced to an RGB value that has an x and y value determining their location on this specific frame. Raw images typically have a bit depth (for the color resolution) and their location in the image is determined by raster scan order. These pixels (from all the frames of group 231) are then converted into a point cloud 232 as described in relation to step 51 of FIG. 4. As shown in FIG. 6, the t axis in the video domain represents time, which in the point cloud domain is translated to a z axis representing depth.

Pixels that are adjacent in a frame are also adjacent in the corresponding point cloud, but in the point cloud, these points are placed with a certain distance between them. Moreover, points that correspond to the same pixel in adjacent frames are also placed with a certain distance between them. These three distances may be the same or may be different. There are several ways of choosing at which distances the points should be placed in the point cloud, including for example:
The same distances are used for all groups of frames. The distances are independent of the content or format of the video. For example, the minimum distance unit supported by the codec may be chosen to reduce the overall occupied volume;
The same distances are used for all groups of frames. The distances depend on the content or format of the video. For example, close to the maximum distance that would allow all the pixels to fit may be chosen (e.g. by dividing the maximum point cloud size by the resolution of the video) to facilitate small displacement of the pixels that might occur if lossy compression is applied;
Different distances are used for at least some groups of frames. The distances depend on the content or format of the video.

If the resolution of a group of frames changes during the video, the size of the point clouds may change during the video as well, e.g. if the same distances are all used for all groups of frames. Alternatively, the size of the point cloud may be kept the same, e.g. by adapting the distances between groups of frames. Preferably, the resolution of the frames does not change during a group of frames to prevent significant metadata overhead.

Based on the chosen distances, it is possible to determine the dimensions of the resulting point cloud. These dimensions may be represented by the distances between the edges of the point cloud in the x, y, and z axes respectively. In the case that a uniform point distance is applied (e.g. distance unit X), the width and height of the point clouds can be calculated by multiplying the width and height (respectively) of each frame with the corresponding chosen distances.

The depth of the point clouds can be calculated by multiplying the Group Of Pictures (GOP) size with the corresponding chosen distance. A group of pictures is a collection of successive pictures within a coded video stream. Each coded video stream consists of successive GOPs, from which the visible frames are generated. A GOP structure specifies the order in which intra- and inter-frames are arranged.

If the dimensions of the point cloud can be determined by the decompression system without metadata, it may be sufficient to include the resolution of the video or the resolutions of the groups of frames in the metadata in order to later reconstruct the frames from the point cloud, or alternatively, to include the chosen distances between points in the x, y, and z dimensions in the metadata (e.g. X if all distances are the same or Xx, Xy and Xz if the distances are not the same). If the dimensions of the point cloud cannot be determined by the decompression system without metadata, these dimensions may be indicated in the metadata in addition to the distances or the resolution(s), or both the resolution of the video/GOPs and the distances may be included in the metadata in order to later reconstruct the frames from the point cloud.

After the pixels from the frames have been converted to a point cloud, this newly made point cloud of points with associated RGB values can be used as an input for a point cloud compression technique that has as base a geometric approach, as described in relation to step 53 of FIG. 4. After receipt of the compressed point cloud, the compressed point cloud is decompressed, and the frames are reconstructed.

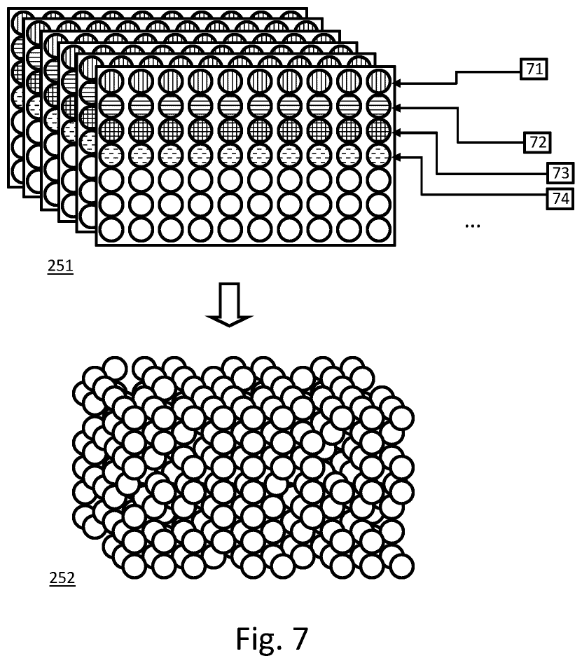

FIG. 7 shows an example of arrays of values derived from sensors other than a camera being converted to a 3D point cloud 252. In this example, instead of using a group of video frames as input, a group 251 of arrays which comprise recordings from various sensors is used as input. Each element of the arrays can be mapped either to one device (e.g. the measurement from a single sensor) or one point of interest (measurements from multiple sensors at the same point of interest—e.g. temperature, humidity and light). The values derived from the sensors (e.g. e.g. temperature, humidity and light) may be inserted into video frames instead of R, G, B color values, e.g. if the compression algorithm/software expects video frames.

The values derived from the sensor may be mapped to a single position in the array (e.g. element 1, 1 has values from sensor 71, element 1,2 has values from sensor 72, element 1,3 has values from sensor 73, element 1,4 has values from sensor 74, etc.), or rows/columns (e.g. element values of row 1 are from sensor 71, element values of row 2 are from sensor 72, element values of row 3 are from sensor 73, element values of row 4 are from sensor 74, etc.). The latter is shown in FIG. 7. For such cases, the metadata created in step 55 of FIG. 5 may indicate from which sensor the element values originate (e.g. that geo-location is in row 1 of the arrays).

The array and the group size may be set according to the system requirements. For example, the size of the arrays may be based on the number of sensors and the number of arrays in a group may depend on the transmission interval. If the values derived from the sensors are placed in video frames, the size of an array is also referred to as the resolution of the video frame and the number of arrays in the group is also referred to as the GOP size. The above-described approach has the potential for high efficiency since in many cases (e.g. weather monitoring) the measurements are fixed for a long period of time.

If there is a variety of sensor sampling rates (e.g. in a system with some sensors sampling at 1 Hz, others at 2 Hz, and others at 5 Hz), there are different approaches possible for handling this. A first possible approach is to use the highest sampling rate and for the intervals that there is no data from other sensors, to leave the value empty. If at a “frame” a value is missing, it can be left blank in the resulting point cloud—since sparse point clouds are the norm (in contrast to the video frames where each pixel should have a value). Point cloud 252 is an example of such a sparse point cloud.

In a first application, the sensors are sensors embedded in a car. Sensor data may be stored for offline processing, for example. Each of the car's sensors may occupy a space in the arrays and each measurement interval may be stored in an individual array.

In another potential application, there is environmental monitoring (e.g. a plethora of sensors recording values over a large, potentially remote, area). These sensors typically have low sampling rates and the formed network is of extremely low bitrate and often of high latency. However, if there is a single point cloud (or video) recording device in the network, the data can be aggregated to that “gateway” node and communicated to the receiver via the high-throughput channel used for the point clouds.

For such cases, and if a high and varying latency is acceptable, data may be gathered, and a group of arrays may be constructed, as soon as there is enough data ready to fill the group. This way, data that arrived late can still be inserted to the respective arrays, as long as they belong to the same plurality/group of arrays. Also, with this approach, synchronization between the different sensors is maintained because each array represents a certain time range. Typically video frames have a point in time associated, but in the non-camera case, an array may be associated with a time range, because multiple time values might be represented in a single array (e.g. if each row contains values derived from the same simple sensor and thus each element value in the row belongs to a different time).

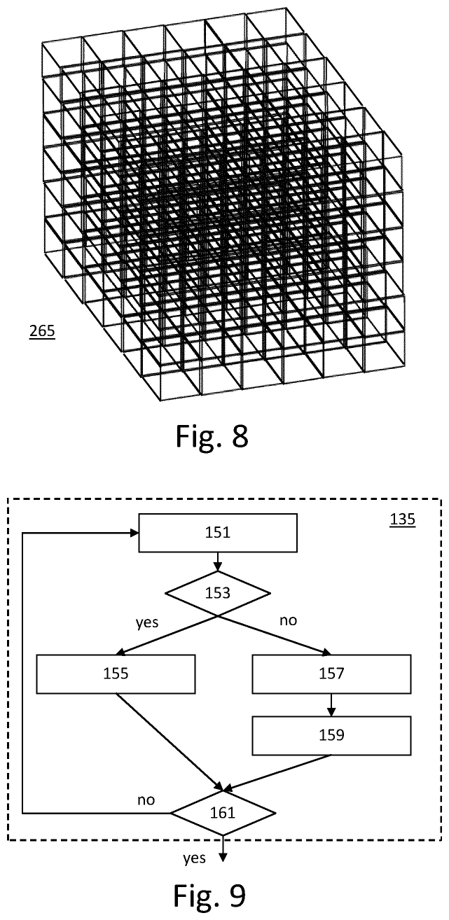

FIG. 8 shows an example of a 3D point cloud divided into 3D subspaces 265, as performed for example in step 125 of FIG. 2. This division may be made based on the dimensions of the 2D arrays and the distances between data points in the 3D point cloud before compression, for example. The dimensions of the 2D arrays and distances between data points in the 3D point cloud before compression may be included in metadata associated with the 3D point cloud, e.g. if they may be different for different video streams.

If the metadata only includes either the dimensions of the 2D arrays or the distances between data points in the 3D point cloud before compression and not both, the omitted parameter may be calculated from the present parameter based on the point cloud dimensions. The point cloud dimensions may be determined from the point cloud itself by determining distances between the leftmost point and the rightmost point, between the top point and the bottom point, and between the farthest point and the closest point. Alternatively, the point cloud dimensions may be included in metadata associated with the 3D point cloud.

In FIG. 8, the 3D point cloud is divided into 6×6×6 3D subspaces, corresponding to six 2D arrays of six rows and six columns. After the 3D point cloud has been divided into 3D subspaces, a corresponding 3D subspace may be selected for each position in the two-dimensional arrays and an element value may be determined for each position in the 2D arrays based on one or more values of one or more data points in the corresponding 3D subspace, as performed for example in steps 133 and 135 of FIG. 2.

Thus, the same distances used for mapping the group of frames 231 to the 3D point cloud 232 of FIG. 6 may be used to extract the RGB frames, i.e. reconstruct the physical structure of the frames as well as ‘color in’ the reconstructed frames. When using lossless compression, this may be implemented by starting from a corner on the first slice (points with same z coordinate belong to the same slice) of the point cloud and iterating on the y and x axes at “point distance” intervals, then moving to a corner of the second slice after all points from the first slice have been extracted, and so forth.

With lossless compression, the distances between the points will be the same as before the compression and the reconstruction will be relatively simple. With lossy compression and smaller distances between points, it might happen that it is not clear which point in the point clouds belongs to which position in the group of arrays. For example, one 3D subspace may be empty, and an adjacent 3D subspace may comprise two points. If the two points do not clearly belong to different 3D subspaces, an average of the values associated with the two points may be determined for the array position that corresponds to the 3D subspace which comprises the two points.

In this case, one or more of the 3D subspaces may be empty while each positions of the arrays may need to have a value. This is typically the case with video frames. Missing RGB values may then be reconstructed by implementing step 135 of FIG. 2 as shown in FIG. 9. In the embodiment of FIG. 9, step 135 comprises sub steps 151, 153, 155, 157, 159, and 161.

In the first iteration of step 151, a first 3D subspace, e.g. of the 3D subspaces 265 of FIG. 8, is selected in step 151. Next, step 153 comprises determining whether the selected 3D subspace comprises at least one data point. If so, step 155 is performed. Step 155 comprises determining an element value for the corresponding position in the 2D arrays based on the one or more values of the one or more data points in the 3D subspace.

If it is determined in step 153 that the selected 3D subspace does not comprise at least one data point, steps 157 and 159 are performed. Step 157 comprises determining a geometrical shape encompassing the selected 3D shape. Step 159 comprises determining an element value for the corresponding position in the 2D arrays based on one or more element values of one or more data points which are part of the determined geometrical shape.

After step 155 or step 159 has been performed, step 161 comprises checking whether the 3D subspace selected in step 151 was the last one of the 3D subspaces. If not, the next 3D subspace is selected in the next iteration of step 151, and the method proceeds as shown in FIG. 9, but now for the next 3D subspace.

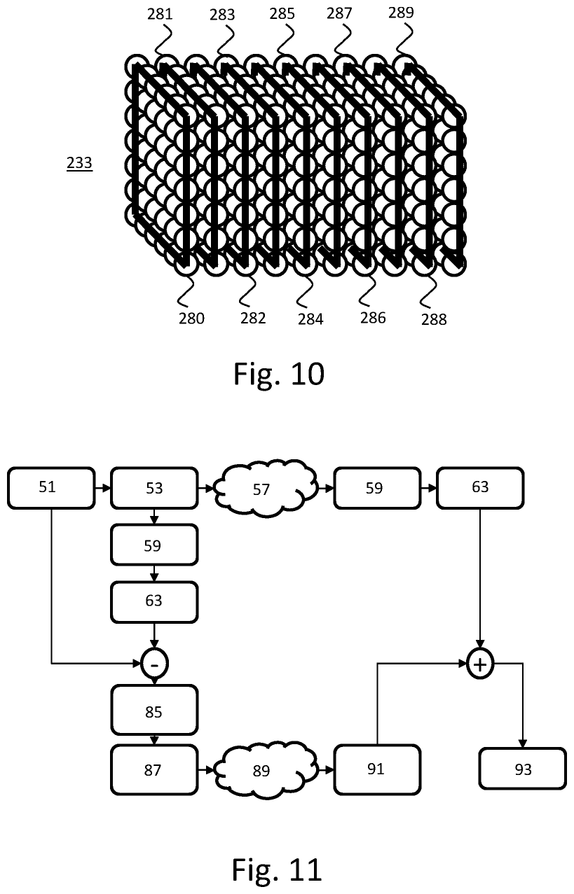

FIG. 10 illustrates a second approach for mapping pixels of a plurality of frames to a 3D point cloud. FIG. 6 has described a first approach in which pixels of a frame are mapped to different x and y positions of a point cloud and different frames are mapped to different z positions of the point cloud. In the approach of FIG. 10, pixels of a frame are mapped to different y and z positions of a point cloud and different frames are mapped to different x positions of the point cloud.

In other words, the group of arrays is sliced differently. In the example of FIG. 10, the point cloud 233 comprises slices 280-289 along the y and z axes instead of along the x and y axes. A different way of slicing may also be used for values derived from sensors other than a camera. For example, the z dimension of the created 3D point cloud might not represent time but might represent the sensor device from which the element value has been derived. In this case, the x or y dimension represents time.

If a group of arrays can be mapped to a 3D point cloud using one of multiple methods, it is important that the decompression system knows which method was used. The reconstruction of the groups of arrays may therefore comprise obtaining metadata identifying the method which was used to map positions of element values in the original plurality of arrays to coordinates of the data points of the three-dimensional point cloud before the three-dimensional point cloud was compressed and selecting the corresponding three-dimensional subspace for each position in the two-dimensional arrays based on the identified method.

In addition to or instead of identifying how the group of arrays was sliced, the metadata may indicate what point cloud coordinate system was used when mapping positions of element values in the original plurality of arrays to coordinates of the data points of the three-dimensional point cloud. The compression system and the decompression system must have a common notion of the coordinate system. For example, the decompression should know which position of a frame corresponds to the point in position (0,0,0) of the point cloud and the positive/negative direction of the axes. For example, in many 2D graphics systems the pixel (0,0) is the leftmost top pixel (i.e. top-left corner) and moving right or down would be positive—i.e. the next diagonal pixel would be at location (1,1), but this is not always the case.

Similarly, some 3D systems have point (0,0,0) at the top-left-back corner and only positive movement on the axis is allowed, but others have point (0,0,0) at the center of the scene/object and moving right, front, up would result in positive values, while left, back, down in negative. For example in a unitary cube object (i.e. each edge length=1 distance units) the top-left-back vertex would be at (0,0,0) and the bottom-right-front at (1,1,1) in the first case, while in the second those values would be (−0.5,−0.5, −0.5) and (0.5, 0.5, 0.5) respectively—with all the other points within those limits.

If the compression system is able to choose one of multiple coordinate systems, metadata associated with the 3D point cloud preferably indicates which coordinate system was used.

FIG. 11 is a flow diagram of a third embodiment of the compression method and a third embodiment of the decompression method. These are variations on the second embodiments of FIG. 4. If the geometry-based point cloud compression used in step 53 of FIG. 5 is by itself not lossless, the quality of the frames overall may be improved by compensating the geometric coding failures that may occur.

After the compression system has compressed the point cloud in step 53, the compression system itself performs steps 59 and 63, which will later be performed by the decompression system. Thus, the compression system decompresses the compressed point cloud and reconstructs the groups of frames immediately after compressing the point cloud.

In a step 85, the decompression system compares the raw (uncompressed) video frames received in step 151 with the result of step 63 and determines the residual difference per frame. This residual difference is then encoded with a conventional video encoder in a step 87 and stored or transmitted in a step 89. After the decompression system receives the encoded residual differences, it decodes them with a conventional video decoder. Then, in a step 93, the reconstructed frames obtained in step 63 by the decompression system are corrected using the residual differences decoded in step 91.

The geometry-based compression performed in step 105 of FIG. 2 and in step 53 if FIGS. 4 and 11 may use a G-PCC or Google Draco encoder, for example. G-PCC encodes point clouds based on voxelization, i.e. quantization compression. It exploits the 3D correlation between points (as the octree/voxelization enables a direct neighborhood access and knowledge).

In geometry-based compression, object detection may be used to identify elementary shapes (cubes, spheres, etc.) of the same color. Then these shapes can be expressed as vectors that require less data to be transmitted (e.g. cube with bottom-left corner at XYZ, of color RGB, with edge of length z). Using this for video compression is often computationally efficient. These elementary shapes in the 3D domain are (in some cases) replacing the blocks used in the 2D domain.

An alternative (or complimentary approach) would be to use meshes. This can be applied by either converting the whole point cloud to meshes (resulting in lossy coding), or by using meshes for the parts of the object for which it is easy to do so and points for the rest, which however is computationally expensive, and non-standard compliant.

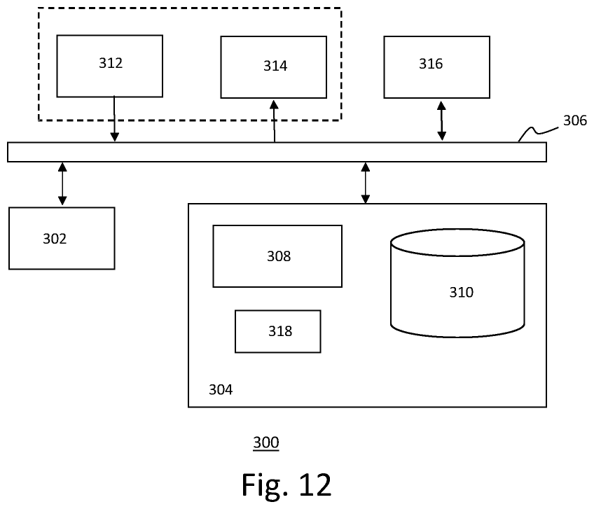

FIG. 12 depicts a block diagram illustrating an exemplary data processing system that may perform the method as described with reference to FIGS. 2, 3, 9, and 11.

As shown in FIG. 12, the data processing system 300 may include at least one processor 302 coupled to memory elements 304 through a system bus 306. As such, the data processing system may store program code within memory elements 304. Further, the processor 302 may execute the program code accessed from the memory elements 304 via a system bus 306. In one aspect, the data processing system may be implemented as a computer that is suitable for storing and/or executing program code. It should be appreciated, however, that the data processing system 300 may be implemented in the form of any system including a processor and a memory that is capable of performing the functions described within this specification.

The memory elements 304 may include one or more physical memory devices such as, for example, local memory 308 and one or more bulk storage devices 310. The local memory may refer to random access memory or other non-persistent memory device(s) generally used during actual execution of the program code. A bulk storage device may be implemented as a hard drive or other persistent data storage device. The processing system 300 may also include one or more cache memories (not shown) that provide temporary storage of at least some program code in order to reduce the number of times program code must be retrieved from the bulk storage device 310 during execution.

Input/output (1/O) devices depicted as an input device 312 and an output device 314 optionally can be coupled to the data processing system. Examples of input devices may include, but are not limited to, a keyboard, a pointing device such as a mouse, or the like. Examples of output devices may include, but are not limited to, a monitor or a display, speakers, or the like. Input and/or output devices may be coupled to the data processing system either directly or through intervening I/O controllers.

In an embodiment, the input and the output devices may be implemented as a combined input/output device (illustrated in FIG. 12 with a dashed line surrounding the input device 312 and the output device 314). An example of such a combined device is a touch sensitive display, also sometimes referred to as a “touch screen display” or simply “touch screen”. In such an embodiment, input to the device may be provided by a movement of a physical object, such as e.g. a stylus or a finger of a user, on or near the touch screen display.

A network adapter 316 may also be coupled to the data processing system to enable it to become coupled to other systems, computer systems, remote network devices, and/or remote storage devices through intervening private or public networks. The network adapter may comprise a data receiver for receiving data that is transmitted by said systems, devices and/or networks to the data processing system 300, and a data transmitter for transmitting data from the data processing system 300 to said systems, devices and/or networks. Modems, cable modems, and Ethernet cards are examples of different types of network adapter that may be used with the data processing system 300.

As pictured in FIG. 12, the memory elements 304 may store an application 318. In various embodiments, the application 318 may be stored in the local memory 308, he one or more bulk storage devices 310, or separate from the local memory and the bulk storage devices. It should be appreciated that the data processing system 300 may further execute an operating system (not shown in FIG. 12) that can facilitate execution of the application 318. The application 318, being implemented in the form of executable program code, can be executed by the data processing system 300, e.g., by the processor 302. Responsive to executing the application, the data processing system 300 may be configured to perform one or more operations or method steps described herein.

Various embodiments of the invention may be implemented as a program product for use with a computer system, where the program(s) of the program product define functions of the embodiments (including the methods described herein). In one embodiment, the program(s) can be contained on a variety of non-transitory computer-readable storage media, where, as used herein, the expression “non-transitory computer readable storage media” comprises all computer-readable media, with the sole exception being a transitory, propagating signal. In another embodiment, the program(s) can be contained on a variety of transitory computer-readable storage media. Illustrative computer-readable storage media include, but are not limited to: (i) non-writable storage media (e.g., read-only memory devices within a computer such as CD-ROM disks readable by a CD-ROM drive, ROM chips or any type of solid-state non-volatile semiconductor memory) on which information is permanently stored; and (ii) writable storage media (e.g., flash memory, floppy disks within a diskette drive or hard-disk drive or any type of solid-state random-access semiconductor memory) on which alterable information is stored. The computer program may be run on the processor 302 described herein.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of embodiments of the present invention has been presented for purposes of illustration, but is not intended to be exhaustive or limited to the implementations in the form disclosed. Many modifications and variations will be apparent to those of ordinary skill in the art without departing from the scope and spirit of the present invention. The embodiments were chosen and described in order to best explain the principles and some practical applications of the present invention, and to enable others of ordinary skill in the art to understand the present invention for various embodiments with various modifications as are suited to the particular use contemplated.

1. A decompression system comprising at least one processor the at least one processor being configured to:
obtain a compressed three-dimensional point cloud,
decompress the compressed three-dimensional point cloud into a three-dimensional point cloud by applying geometry-based point cloud decompression to the compressed three-dimensional point cloud, and
convert the point cloud to a plurality of two-dimensional arrays of element values by dividing the three-dimensional point cloud into a plurality of three-dimensional subspaces, selecting a corresponding three-dimensional subspace for each position in the two-dimensional arrays, and determining an element value for each position in the two-dimensional arrays based on one or more values of one or more data points in the corresponding three-dimensional subspace, same positions in each of the plurality of two-dimensional arrays comprising a value of the same element at a different moment.

2. A decompression system as claimed in claim 1, wherein the two-dimensional arrays of element values are frames comprising pixel values.

3. A decompression system as claimed in claim 1, wherein the element values comprise values derived from at least one sensor.

4. A decompression system as claimed in claim 3, wherein the element values comprise color values.

5. A decompression system as claimed in claim 1, wherein the at least one processor is configured to obtain metadata indicating dimensions of the plurality of two-dimensional arrays and divide the three-dimensional point cloud into the plurality of three-dimensional subspaces based on the indicated dimensions.

6. A decompression system as claimed in claim 5, wherein the at least one processor is configured to determine point cloud dimensions of the three-dimensional point cloud and divide the three-dimensional point cloud into a plurality of three-dimensional subspaces further based on the determined point cloud dimensions.

7. A decompression system as claimed in claim 5, wherein the at least one processor is configured to obtain metadata indicating distances between data points in the three-dimensional point cloud before compression and divide the three-dimensional point cloud into the plurality of three-dimensional subspaces further based on the indicated distances.

8. A decompression system as claimed in claim 1, wherein the compressed three-dimensional point cloud was compressed using lossy geometry-based point cloud compression and the at least one processor is configured to determine for each position in the two-dimensional arrays whether the corresponding three-dimensional subspace comprises at least one data point and if a three-dimensional subspace corresponding to a position in the two-dimensional arrays does not comprise a data point, determine a geometrical shape encompassing the three-dimensional subspace and determine an element value for the position based on one or more element values of one or more data points which are part of the determined geometrical shape.

9. A decompression system as claimed in claim 1, wherein the at least one processor is configured to obtain metadata identifying a method which was used to map positions of element values in an original plurality of arrays to coordinates of the data points of the three-dimensional point cloud before the three-dimensional point cloud was compressed and select the corresponding three-dimensional subspace for each position in the two-dimensional arrays based on the identified method.

10. A decompression system as claimed in claim 1, wherein the decompression system is a terminal.

11. A compression system comprising at least one processor, the at least one processor being configured to:
obtain a plurality of two-dimensional arrays of element values, same positions in each of the plurality of two-dimensional arrays comprising a value of the same element at a different moment,
convert the plurality of two-dimensional arrays of element values to a three-dimensional point cloud comprising a plurality of data points by mapping the positions of the element values in the plurality of two-dimensional arrays to coordinates of the data points and associating each of the element values with a corresponding data point in the point cloud, and
compress the three-dimensional point cloud into a compressed three-dimensional point cloud by applying geometry-based point cloud compression to the three-dimensional point cloud.

12. A compression system claimed in claim 11, wherein the at least one processor is configured to determine desired distances between data points in the three-dimensional point cloud and map the positions of the element values in the plurality of two-dimensional arrays to coordinates of the data points based on the desired distances.

13. A compression system as claimed in claim 11, wherein the at least one processor is configured to associate metadata indicating dimensions of the plurality of two-dimensional arrays, dimensions of the three-dimensional point cloud, and/or the desired distances with the compressed three-dimensional point cloud.

14. A method of decompressing compressed two-dimensional arrays of element values, the method comprising:
obtaining a compressed three-dimensional point cloud;
decompressing the compressed three-dimensional point cloud into a three-dimensional point cloud by applying geometry-based point cloud decompression to the compressed three-dimensional point cloud; and
converting the point cloud to a plurality of two-dimensional arrays of element values by dividing the three-dimensional point cloud into a plurality of three-dimensional subspaces, selecting a corresponding three-dimensional subspace for each position in the two-dimensional arrays, and determining an element value for each position in the two-dimensional arrays based on one or more values of one or more data points in the corresponding three-dimensional subspace, same positions in each of the plurality of two-dimensional arrays comprising a value of the same element at a different moment.

15. A method of compressing two-dimensional arrays of element values, the method comprising:
obtaining a plurality of two-dimensional arrays of element values, same positions in each of the plurality of two-dimensional arrays comprising a value of the same element at a different moment;
converting the plurality of two-dimensional arrays of element values to a three-dimensional point cloud comprising a plurality of data points by mapping the positions of the element values in the plurality of two-dimensional arrays to coordinates of the data points and associating each of the element values with a corresponding data point in the point cloud, and
compressing the three-dimensional point cloud into a compressed three-dimensional point cloud by applying geometry-based point cloud compression to the three-dimensional point cloud.

16. A computer program product for a computing device, the computer program product comprising computer program code to perform the method of claim 15 when the computer program product is run on a processing unit of the computing device.
